(19) United States
(12) Patent Application Publication
(10) Pub. No.: US 2005/0040964 A1
(43) Pub. Date: Feb. 24, 2005

(54) Alternative hard drive activity indicator

(76) Inventor: Keith C. Thomas, Vermillion, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/646,162

(22) Filed: Aug. 22, 2003

(51) Int. Cl. G08B 5/22

(52) U.S. Cl. 340/815.45; 340/635

(57) ABSTRACT

A computer system is provided with an alternate activity indicator visible from a front panel which is illuminated in response to a first continuous operating condition. An activity detection circuit coupled to the indicator generates an activity signal indicating a second periodic operating condition associated with a HDD and communicates the activity signal to the indicator to interrupt illumination. The indicator produces an indication of the second periodic operating condition during intervals when the indicator is interrupted from illuminating.

### FIELD OF THE INVENTION

The present invention generally relates to the field of status and activity indicators for electronic devices, and the like, and particularly to an alternative indicator for hard drive status and activity.

### BACKGROUND OF THE INVENTION

Indicators associated with the operational status of electronic devices are well known. The benefits associated with understanding the operational status of an electronic device so as to reconcile the expected condition with the actual condition cannot be disputed. Users may be spared undue anxiety by providing activity indications so that during periods of time intensive operations such as disk accesses, the user may at least be able to determine that “something” is happening, versus wondering whether a system is “hung” or has otherwise become unresponsive.

Many computer components come from the Original Equipment Manufacturer (OEM) with indicator LEDs. For example, a typical Hard Disk Drive (HDD) has an LED indicator mounted to the case thereof. However, the location of some of these components within the system prevents the LEDs originally installed from being seen. One solution to this problem, proposed in U.S. Pat. No. 6,492,908 B1 issued on Dec. 10, 2002 to Cheng, involves the use of light-transmissible case so that LEDs on internal components can be viewed through the case. Many manufacturers route a conductor to a front panel with an auxiliary LED to indicate, for example, disk drive activity.

In order to save costs, however, some computer manufactures have abandoned the use of certain auxiliary indicators such as hard drive LED indicators on some computer models. Consequently many users, particularly those from associated with corporate enterprises may find that the lack of a hard drive LED activity indicator is troublesome. Moreover, to the extent that competing manufacturers still have activity indicators on their systems, the lack of an indicator can become a competitive disadvantage.

Simple indicators have been described for example, in U.S. Pat. No. 5,214,762 issued on May 25, 1993 to Bush, et al wherein an LED mounted on the front panel of a computer remote from the associated hard drive may be triggered in response to various inputs such as I/O writes, hard drive interrupt requests, and the like. Bush shows mounting the disk activity LED in a convenient place, e.g. a place viewable from the front panel, from a mounting position on, for example, the front of a power supply and using extra conductors found on the ribbon cable typically supplied with disk drives and power supplies to control and trigger the dedicated LED. It should be noted that Bush fails to describe the placement or operation of a conventional Power On indicator. It is clear however that LED 32, while mounted on the power supply, is not a power-on related indicator.

Other indicators have been described for reflecting power consumption status. In U.S. Pat. No. 5,941,989 issued on Aug. 24, 1999 to Klein, for example, the apparent intensity of an LED is controlled by a pulsed LED control signal with an adjustable duty cycle. Thus a plurality of duty cycles affecting LED intensity may corresponds to a plurality of power consumption states.

The idea of providing multiple indications with a single LED has also been proposed in U.S. Pat. No. 4,837,565 issued on Jun. 6, 1989 to White, where, for example, a bi-color LED is used to indicate three states. Detection of a first state results in a first color being lighted, detection of a second state results in a second color being lighted, and detection of a third state results in the LED being lighted with the first and the second color at a sufficiently high rate to cause the LED to appear as a third color.

Problems arise however in that the provision of indicators has costs associated therewith, which, in some instances are duplicative, e.g. since many devices already have an OEM indicator. Further, the addition of indicators previously removed from a design for cost reduction related concerns requires re-incurring costs previously saved. Often such costs may be more than might have originally been incurred due in part to factors such as, for example, retooling of cases, establishing or renewing favorable purchasing agreements for the indicator parts and the like. Moreover, automated BOMs will require modification affecting system IDs, and so on down the manufacturing chain.

Consequently, it would be desirable to provide a means to provide an indication without the addition of new parts and associated costs of retooling and the like, wherein the indication may be provided using components already in use on the system or at least with a minimum of new parts.

### SUMMARY OF THE INVENTION

Accordingly, the present invention is directed to an alternate hard drive activity indicator where an indicator, visible from a front panel, and illuminated to show a first operating condition, is modulated by blanking to provide an indication of a second operating condition different from the first operating condition.

In one embodiment, the alternate activity includes an activity indicator, such as a single color LED or the like, visible from a front panel of the electronic device. The activity indicator is preferably configured to provide a continuous indication, e.g. continuous illumination of the LED, of the presence of a first continuous operating condition associated with the electronic device. An activity detection circuit may be coupled to the activity indicator to generate an activity signal when detecting a second periodic operating condition associated with the component, e.g HDD accesses, IO reads or writes associated with the HDD, or interrupts associated with the HDD. The activity signal may be communicated to the activity indicator, or a driver or driver circuit associated therewith, whereupon the activity indicator is preferably interrupted from continuously indicating the presence of the first continuous operating condition by the activity signal. An indication of the second periodic operating condition is thereby produced as intervals when the indicator is interrupted. It should be noted that the first continuous operating condition preferably includes a power-on operating condition, and the second periodic operating condition preferably includes a HDD operating condition. As previously noted the activity indicator includes a single color LED, though lamps or other illuminating means may be used provided the responsiveness is such that short bursts of activity may be indicated thereon. The electronic device may include a computer system and the component may include a HDD.

In accordance with another embodiment, a computer system is provided having an indicator capable of providing illumination and visible from a front panel of the computer system in response to the presence of a first continuous operating condition, e.g. power-on. An activity detection circuit coupled to the indicator may further be provided capable of generating an activity signal indicative of the presence of a second periodic operating condition associated with a component, such as, for example, a HDD of the computer system. The activity signal may be communicated to the indicator which may be thereby be interrupted from illuminating in response to the presence of the first continuous operating condition. An indication of the second periodic operating condition is thereby produced comprising intervals when the indicator is interrupted from illuminating. As previously described, the first continuous operating condition includes a power-on operating condition, and the second periodic operating condition includes a HDD operating condition. The activity indicator may preferably include a single color LED, though lamps or other illuminating means may be used provided the responsiveness is such that short bursts of activity may be indicated thereon.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1A is a diagram illustrating a conventional computer system employing a separate HDD activity indicator;

FIG. 1B is diagram illustrating a conventional computer system employing a separate HDD activity indicator in greater detail;

FIG. 2A is a diagram illustrating an exemplary computer system employing an alternate HDD indicator in accordance with an exemplary embodiment of the present invention;

FIG. 2B is a diagram illustrating an exemplary computer system employing an alternate HDD indicator in accordance with an alternative exemplary embodiment of the present invention;

FIG. 3A is a block diagram illustrating an exemplary circuit for an alternate HDD indicator in accordance with an exemplary embodiment of the present invention; and

FIG. 3B is a detailed block diagram illustrating an exemplary circuit for an alternate HDD indicator in accordance with an exemplary embodiment of the present invention.

### DETAILED DESCRIPTION OF THE INVENTION

Accordingly, the present invention is directed to an alternate hard drive activity indicator where an indicator, visible from a front panel, and illuminated to show a first operating condition, is modulated by blanking to provide an indication of a second operating condition different from the first operating condition. Reference will now be made in detail to the presently preferred embodiments of the invention, examples of which are illustrated in the accompanying drawings.

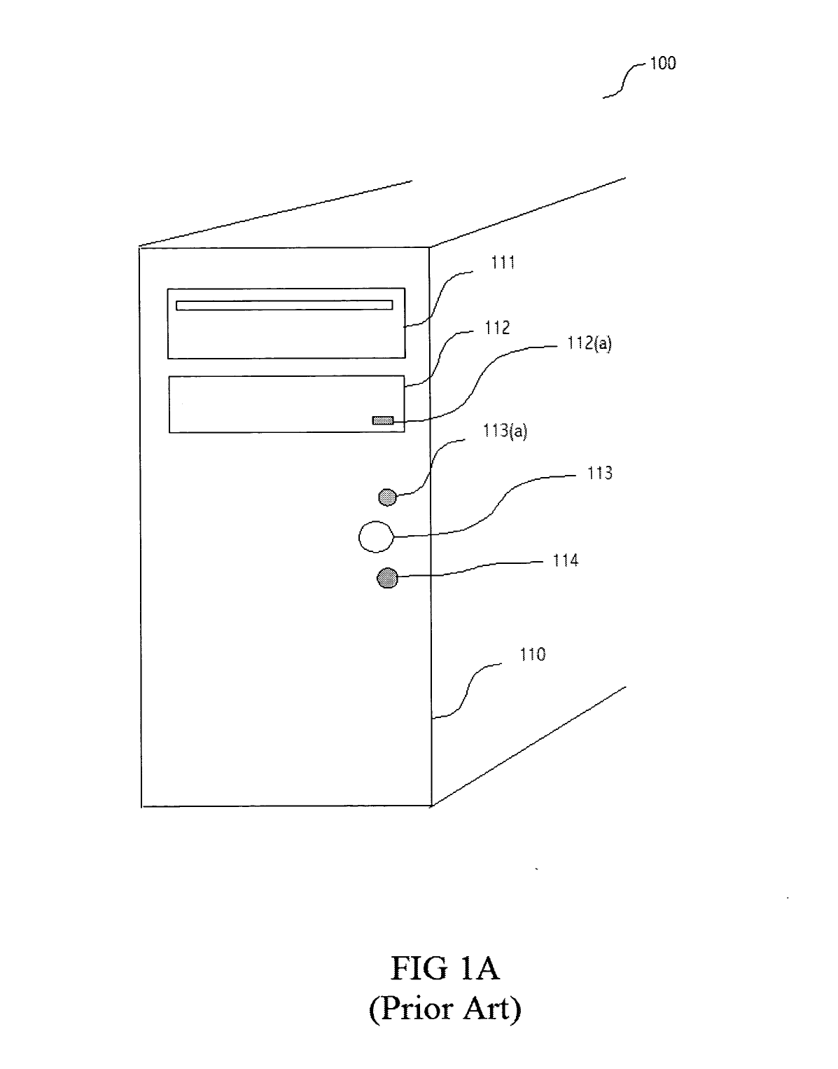

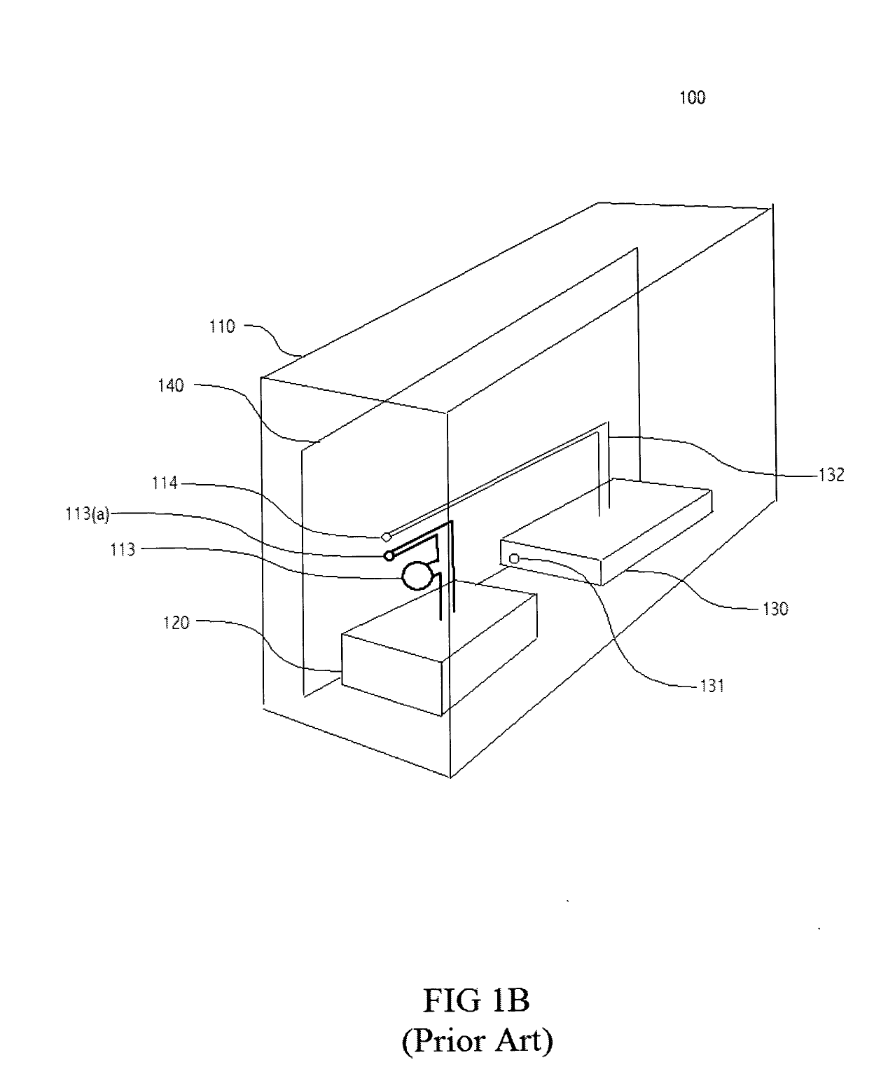

As described above, conventional systems typically employ both a power-on indicator and a HDD indicator both located on the front panel as illustrated in exemplary scenario 100 shown in FIG. 1. Therein, a front panel of conventional computer system 110 is shown with a typical collection of peripherals and attendant indicators. For example, conventional computer system 110 may be equipped with optical drive 111, HDD 112 with activity indicator 112(a), power on switch 113 and power on indicator 113(a), and HDD indicator 114. It should be noted that while HDD 112 is shown with an integrated activity indicator 112(a) visible from the front panel, modern practice is to locate HDD 112 within the confines of an enclosure such that HDD indicator 112(a) would not be visible. Such remote location of HDD 112 was the primary motivation to provide computer system 110 with a front panel indication of HDD activity, for example, through HDD indicator 114. Such a placement however, as described, requires the use of at least an additional LED and conductor as shown in FIG. 1B. through 6 illustrate display assemblies employing a

Since no media is interchangeable within a typical HDD, a more advantageous location for a HDD is within the confines of computer system 110. For example, as shown in FIG. 1B, HDD 130 may be located toward the rear of an enclosure associated with computer system 110 with components such as power supply 120 and motherboard 140. It should be noted that HDD 130 may be provided with activity indicator 131 and conductor 132 to route drive signals to HDD indicator 114 which is typically an LED or the like. It should further be noted that as distinguished from typical power on indicator 113(a), which provides an indication of a continuous operating condition, e.g. power-on, by providing continuous illumination, HDD indicator 114 illuminates only when a periodic operating condition is detected, e.g. HDD activity, thus saving power when no HDD activity is occurring.

As noted, it would be advantageous to eliminate the additional LED associated with HDD indicator 114 and even conductor 132 in order to save production costs. Bush, id, eliminates the HDD activity conductor, e.g. by using a conductor already supplied in typical power supplies. However, the need for a conductor, even if separately provided, in addition to the need for a separate LED remains. Thus, in accordance with the present invention, a the need for a separate LED is obviated since an indicator for a first operating condition, e.g. a power on indicator, is used to provide a separate indication of a second operating condition, preferably by blanking the indication for the first operating condition.

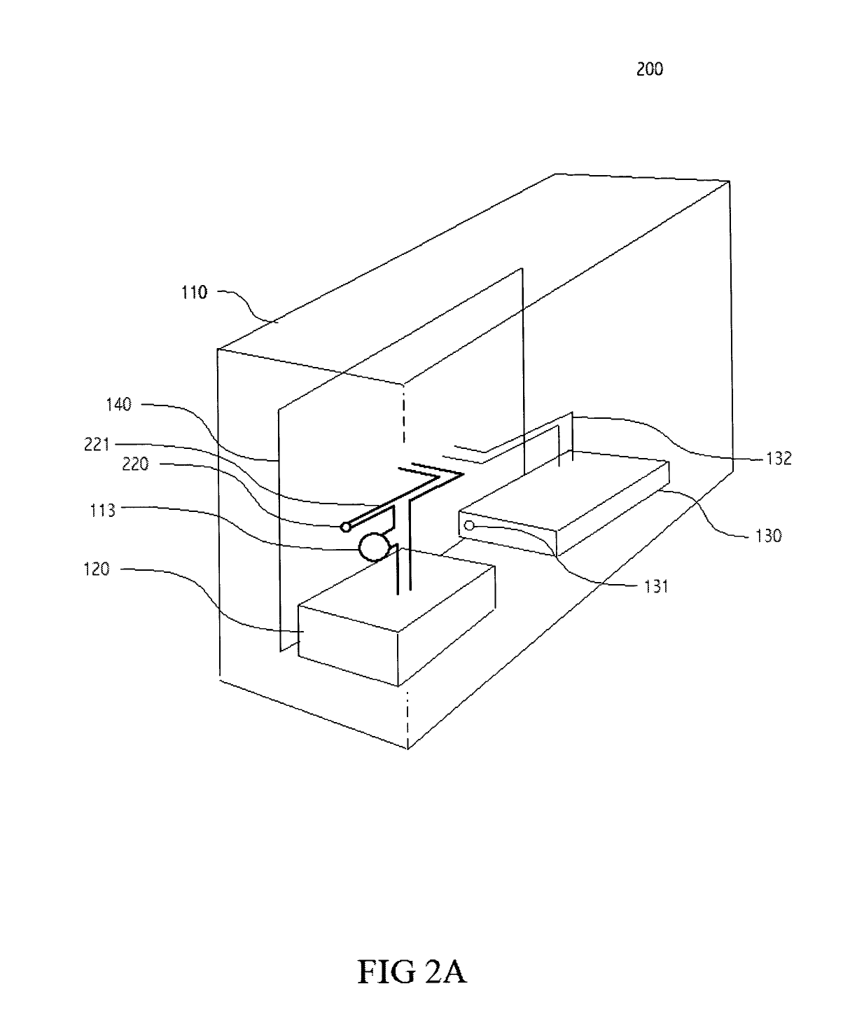

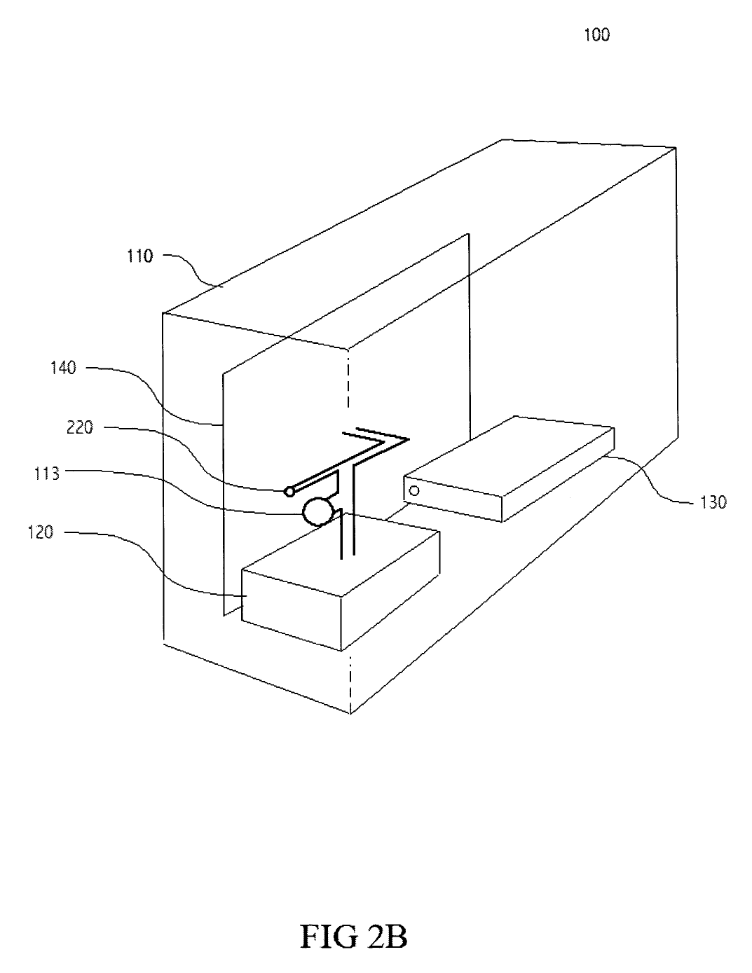

In accordance with various exemplary and alternative exemplary embodiments, the present invention further allows a power savings to be realized since, for example, a power on indicator, which is normally continuous, is periodically interrupted to indicate the presence of activity associated with a periodic operating condition, e.g. HDD activity. It is preferable to use as a first operating condition a constant value such as a power indicator, such that a variable value may suitably be indicated as a second operating condition. Exemplary scenario 200 for example as shown in FIG. 2A, includes one exemplary embodiment of the present invention where conductor 132, which carries an activity indication signal from HDD 130, is routed to logic on motherboard 140 responsible for either communicating, for example, a blanking signal to driver circuit 221 to first and second operating condition indicator 220, or otherwise inhibiting the indication of the first operating condition to provide the indication of the second operating condition. FIG. 2B shows another embodiment where conductor 132 is eliminated all together. As will be described in greater detail hereinafter, logic may be provided, for example, on motherboard 140, or existing hardware may be used to determine activity by, for example, monitoring HDD addresses, interrupt request lines, and the like which would be determinative of HDD activity.

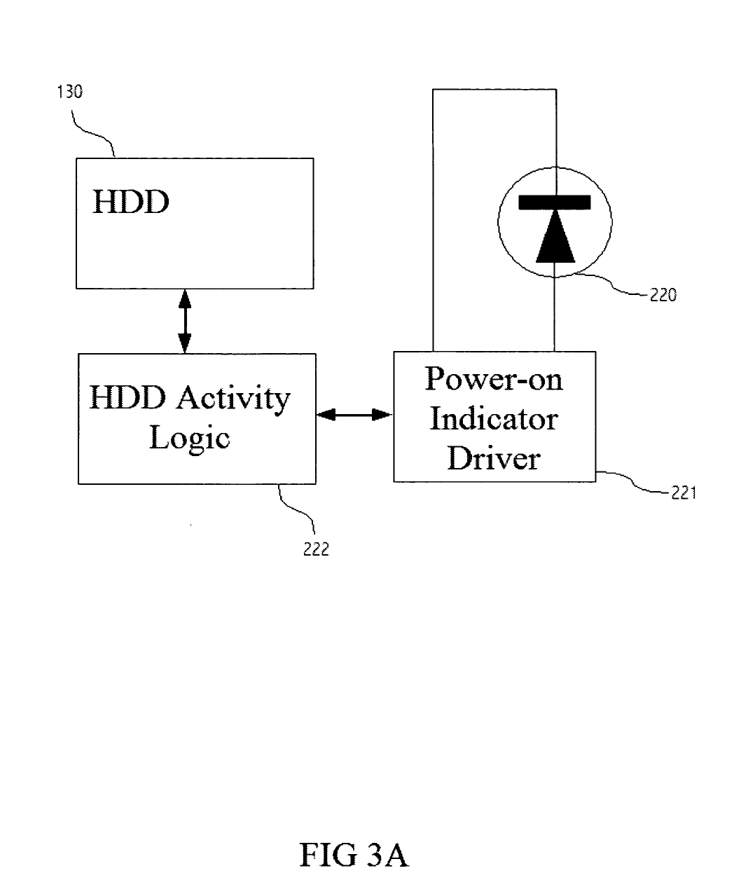

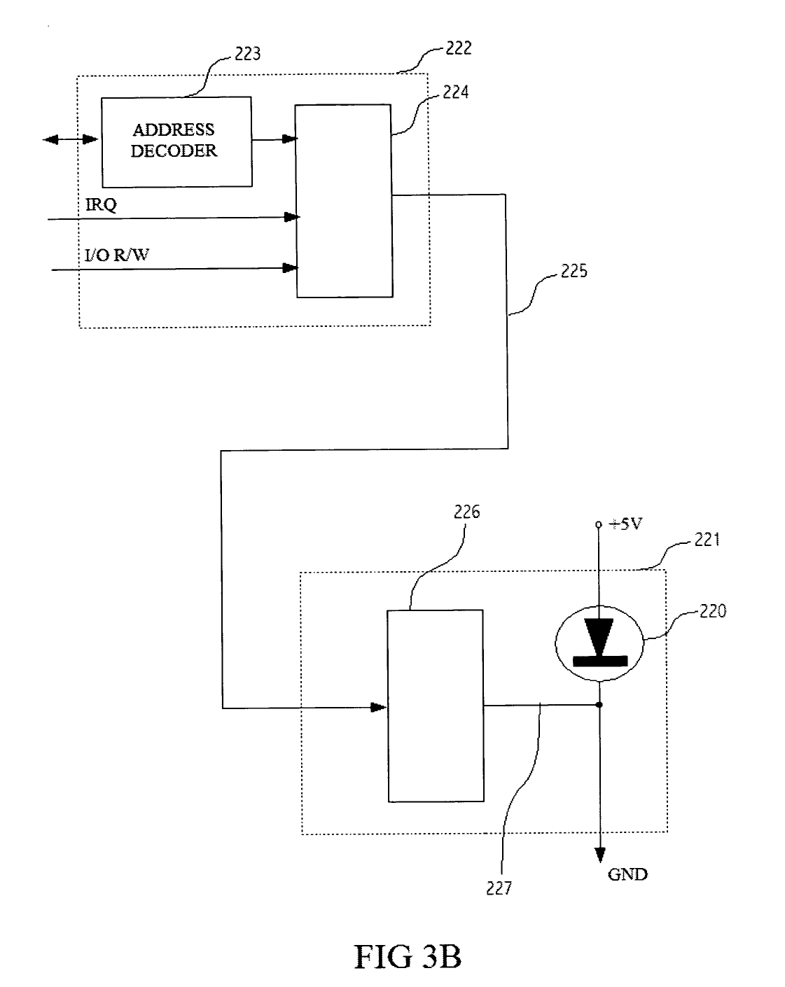

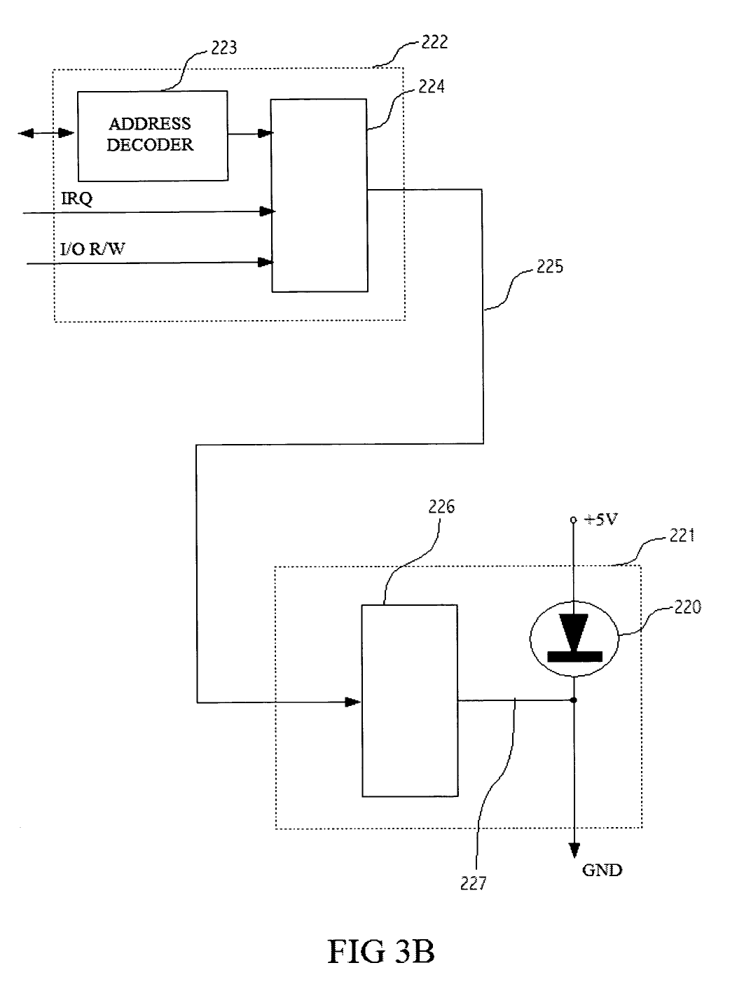

Thus as shown in FIG. 3A, activity associated with HDD 130 may be monitored via HDD activity detection logic 222 to provide a blanking signal or other signal indicative of activity associated with the second operating condition, e.g. HDD activity. HDD detection logic 222 may communicate directly to driver circuit 221 for blanking of first and second operating condition indicator 220, which may be a single color LED or the like.

To better understand the operation of the present invention, FIG. 3B shows HDD detection logic 222 and driver circuit 221 in greater detail. It can be seen that address decoder 223, which may be hardware or, more preferably software, may be used to monitor any addresses which are within the desired range, e.g. the address range of HDD 130 and provide an output signal when such an address is selected. In addition, the appropriate interrupt request line for HDD 130 and I/O read or write lines may further be monitored. Combination logic 224, which may be a multiplexer or other logic capable of generating and outputting activity signal 225 whenever activity associated with and indicative of the second operating condition is present on the interrupt or I/O read/write lines, or address decoder 223, e.g. activity associated with HDD 130. Activity signal 225 may be coupled to driver logic 226 which may be any one of a number of suitable interfaces for receiving activity signal 225 and generating a blanking signal 227. As will be appreciated, blanking signal 227 is preferably active high, e.g. goes from a logic low to a logic high when activity associated with the second operating condition is present. In accordance with the diagram of first and second operating condition indicator 220, a logic high on blanking signal 227 will cause the LED to shut off indicating the second operating condition while a low on blanking signal 227 will cause the LED to illuminate indicating the first operating condition.

It is believed that the alternative hard drive activity indicator of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. An alternate activity indicator for a component of an electronic device comprising:
an activity indicator visible from a front panel of the electronic device, the activity indicator configured to provide a continuous indication of the presence of a first continuous operating condition associated with the electronic device; and
an activity detection circuit coupled to the activity indicator, the activity detection circuit configured to generate an activity signal when detecting a second periodic operating condition associated with the component, and to communicate the activity signal to the activity indicator;
wherein the activity indicator is interrupted from continuously indicating the presence of the first continuous operating condition by the activity signal, thereby producing an indication of the second periodic operating condition.

2. An alternate activity indicator according to claim 1, wherein the first continuous operating condition includes a power-on operating condition, and the second periodic operating condition includes a HDD operating condition.

3. An alternate activity indicator according to claim 1, wherein the activity indicator includes a single color LED.

4. An alternate activity indicator according to claim 1, wherein the electronic device includes a computer system, and wherein the component includes a HDD.

5. A computer system having an alternate activity indicator comprising:
an indicator capable of providing illumination and visible from a front panel of the computer system, the illumination in response to the presence of a first continuous operating condition; and
an activity detection circuit coupled to the indicator, the activity detection circuit capable of generating an activity signal indicative of the presence of a second periodic operating condition associated with a component of the computer system, and to communicate the activity signal to the indicator;
wherein the indicator is capable of being interrupted from illuminating in response to the presence of the first continuous operating condition by the activity signal, and is thereby capable of producing an indication of the second periodic operating condition comprising intervals when the indicator is interrupted from illuminating in response to the presence of the first continuous operating condition.

6. A computer system according to claim 1, wherein the first continuous operating condition includes a power-on operating condition, and the second periodic operating condition includes a HDD operating condition.

7. A computer system according to claim 1, wherein the activity indicator includes a single color LED.
